(19) United States
(12) Patent Application Publication
(10) Pub. No.: US 2002/0025034 A1
(43) Pub. Date: Feb. 28, 2002

(54) Cryptographic encryption method using efficient elliptic curve

(76) Inventor: Jerome Anthony Solinas, Westminster, MD (US)

Correspondence Address: ATTN: PATENT COUNSEL, OGC, NATIONAL SECURITY AGENCY, STE 6542, 9800 SAVAGE ROAD, FT MEADE, MD, 20755-6542, US

(21) Appl. No.: 09/928,703

(22) Filed: Aug. 9, 2001

Related U.S. Application Data
(60) Provisional application No. 60/226,213, filed on Aug. 18, 2000.

(51) Int. Cl. H04L 9/30; G06F 7/49

(52) U.S. Cl. 380/30; 380/44; 708/492

(57) ABSTRACT

A method of cryptographic encryption and decryption by a recipient selecting a modulus p from p=(2^{dk}−2^{ck}−1)/r; p=(2^{dk}−2^{(d-1)k}+2^{(d-2)k}−. . . −2^{k}+1)/r; p=(2^{dk}−2^{ck}−1)/r; p=(2^{dk}−2^{ck}+1)/r; and p=(2^{4k}−2^{3k}+2^{2k}+1)/r; the recipient selecting a curve E and an order q; the recipient selecting a base point G=(Gₓ, G_{y}) on the elliptic curve E; the recipient generating a private integer w; the recipient generating a public key W, where W=wG; the recipient distributing p, E, q, G, and W in an authentic manner; a sender retrieving the recipient's public key W; the sender generating a private integer r; the sender generating R=rG using the form of recipient's modulus p, and where G is recipient's basepoint; the sender combining r, W, and M using the form of recipient's modulus p to form ciphertext C; the sender sending (R,C) to the recipient; the recipient retrieving its private key w; the recipient receiving (R, C); and the recipient combining R, w, and C using the form of recipient's modulus p to recover M.

This application claims the benefit of U.S. Provisional Application No. 60/226,213, filed Aug. 18, 2000.

### FIELD OF THE INVENTION

The present invention relates, in general, to cryptography and, in particular, electronic signal modification (e.g., scrambling).

### BACKGROUND OF THE INVENTION

Cryptography provides methods of providing privacy and authenticity for remote communications and data storage. Privacy is achieved by encryption of data, usually using the techniques of symmetric cryptography (so called because the same mathematical key is used to encrypt and decrypt the data). Authenticity is achieved by the functions of user identification, data integrity, and message non-repudiation. These are best achieved via asymmetric (or public-key) cryptography.

In particular, public-key cryptography enables encrypted communication between users that have not previously established a shared secret key between them. This is most often done using a combination of symmetric and asymmetric cryptography: public-key techniques are used to establish user identity and a common symmetric key, and a symmetric encryption algorithm is used for the encryption and decryption of the actual messages. The former operation is called key agreement. Prior establishment is necessary in symmetric cryptography, which uses algorithms for which the same key is used to encrypt and decrypt a message. Public-key cryptography, in contrast, is based on key pairs. A key pair consists of a private key and a public key. As the names imply, the private key is kept private by its owner, while the public key is made public (and typically associated to its owner in an authenticated manner). In asymmetric encryption, the encryption step is performed using the public key, and decryption using the private key. Thus the encrypted message can be sent along an insecure channel with the assurance that only the intended recipient can decrypt it.

The key agreement can be interactive (e.g., for encrypting a telephone conversation) or non- interactive (e.g., for electronic mail).

User identification is most easily achieved using what are called identification protocols. A related technique, that of digital signatures, provides data integrity and message non-repudiation in addition to user identification.

The use of cryptographic key pairs was disclosed in U.S. Pat. No. 4,200,770, entitled “CRYPTOGRAPHIC APPARATUS AND METHOD.” U.S. Pat. No. 4,200,770 also disclosed the application of key pairs to the problem of key agreement over an insecure communication channel. The algorithms specified in this U.S. Pat. No. 4,200,700 rely for their security on the difficulty of the mathematical problem of finding a discrete logarithm. U.S. Pat. No. 4,200,770 is hereby incorporated by reference into the specification of the present invention.

In order to undermine the security of a discrete-logarithm based cryptoalgorithm, an adversary must be able to perform the inverse of modular exponentiation (i.e., a discrete logarithm). There are mathematical methods for finding a discrete logarithm (e.g., the Number Field Sieve), but these algorithms cannot be done in any reasonable time using sophisticated computers if certain conditions are met in the specification of the cryptoalgorithm.

In particular, it is necessary that the numbers involved be large enough. The larger the numbers used, the more time and computing power is required to find the discrete logarithm and break the cryptography. On the other hand, very large numbers lead to very long public keys and transmissions of cryptographic data. The use of very large numbers also requires large amounts of time and computational power in order to perform the cryptoalgorithm. Thus, cryptographers are always looking for ways to minimize the size of the numbers involved, and the time and power required, in performing the authentication algorithms. The payoff for finding such a method is that cryptography can be done faster, cheaper, and in devices that do not have large amounts of computational power (e.g., hand-held smart-cards).

A discrete-logarithm based cryptoalgorithm can be performed in any mathematical setting in which certain algebraic rules hold true. In mathematical language, the setting must be a finite cyclic group. The choice of the group is critical in a cryptographic system. The discrete logarithm problem may be more difficult in one group than in another for which the numbers are of comparable size. The more difficult the discrete logarithm problem, the smaller the numbers that are required to implement the cryptoalgorithm. Working with smaller numbers is easier and faster than working with larger numbers. Using small numbers allows the cryptographic system to be higher performing (i.e., faster) and requires less storage. So, by choosing the right kind of group, a user may be able to work with smaller numbers, make a faster cryptographic system, and get the same, or better, cryptographic strength than from another cryptographic system that uses larger numbers.

The groups which were envisioned in the above-named patents come from a setting called finite fields. A book by N. Koblitz, “A Course in Number Theory and Cryptography,” (1987), and a paper by V. Miller, “Use of elliptic curves in cryptography,” Advances in Cryptology-CRYPTO 85, LNCS 218, pp. 417-426, 1986, disclose the method of adapting discrete-logarithm based algorithms to the setting of elliptic curves. It appears that finding discrete logarithms in this kind of group is particularly difficult. Thus elliptic curve-based cryptoalgorithms can be implemented using much smaller numbers than in a finite-field setting of comparable cryptographic strength. Thus the use of elliptic curve cryptography is an improvement over finite-field based public-key cryptography.

There are several kinds of elliptic curve settings. These settings have comparable cryptographic strength and use numbers of comparable size. However, these settings differ in the amount of computation time required when implementing a cryptoalgorithm. Cryptographers seek the fastest kind of elliptic curve based cryptoalgorithms.

More precisely, an elliptic curve is defined over a field F. An elliptic curve is the set of all ordered pairs (x,y) that satisfy a particular cubic equation over a field F, where x and y are each members of the field F. Each ordered pair is called a point on the elliptic curve. In addition to these points, there is another point O called the point at infinity. The infinity point is the additive identity (i.e., the infinity point plus any other point results in that other point). For cryptographic purposes, elliptic curves are typically chosen with F as the integers mod p for some large prime number p (i.e., Fp) or as the field of 2ˆ m elements.

To carry out an elliptic curve-based key agreement procedure, it is necessary to perform a sequence of operations involving points on the curve and the equation of the curve. Each of these operations is carried out via arithmetic operations in the field F, namely addition, subtraction, multiplication, and division. If F is the set of integers mod p, then the simplest and most common way to carry out the arithmetic operations is to use ordinary integer arithmetic along with the process of reduction modulo p. This last process is called modular reduction.

Modular reduction is the most expensive part of the arithmetic operations in the field Fp. Therefore, the efficiency of an elliptic curve algorithm is enhanced when the cost of modular reduction is reduced. There are two common ways of doing this.

The first way is to avoid explicit modular reduction altogether by using an alternative method of carrying out the arithmetic operations in the field Fp. This was first proposed by P. Montgomery in the paper “Modular multiplication without trial division,” Mathematics of Computation, 44 (1985), pp. 519-521. This method has the advantage that it can be applied to both elliptic and non-elliptic cryptoalgorithms.

The second way is to choose the prime modulus p in such a way that modular reduction is particularly easy and efficient. This approach yields faster elliptic curve algorithms than the first approach, but does not apply to non-elliptic cryptoalgorithms.

More specifically, suppose that one needs to reduce an integer b modulo p. Typically, b is a positive integer less than the square of the modulus p. In the general case, the best way to reduce b modulo p is to divide b by p; the result is a quotient and a remainder. The remainder is the desired quantity. The division step is the most expensive part of this process. Thus the prime modulus p is chosen to avoid the necessity of carrying out the division.

The simplest and best-known choice is to let p be one less than a power of two. Such primes are commonly called Mersenne primes. Because of the special form of a Mersenne prime p, it is possible to replace the division step of the modular reduction process by a single modular addition. A modular addition can be carried out using one or two integer additions, and so is much faster than an integer division. As a result, reduction modulo a Mersenne prime is much faster than in the general case.

A larger class of primes which contains the Mersenne primes as a special case is the class of pseudo-Mersenne primes. These include the Crandall primes and the Gallot primes. The Crandall primes are those of the form 2ˆ m±C, where C is an integer less than 2ˆ 32 in absolute value. The Gallot primes are of the form k*2ˆ m±C, where both k and C are relatively small.

U.S. Pat. Nos. 5,159,632, entitled “METHOD AND APPARATUS FOR PUBLIC KEY EXCHANGE IN A CRYPTOGRAPHIC SYSTEM”; 5,271,061, entitled “METHOD AND APPARATUS FOR PUBLIC KEY EXCHANGE IN A CRYPTOGRAPHIC SYSTEM”; 5,463,690, entitled “METHOD AND APPARATUS FOR PUBLIC KEY EXCHANGE IN A CRYPTOGRAPHIC SYSTEM”; 5,581,616, entitled “METHOD AND APPARATUS FOR DIGITAL SIGNATURE AUTHENTICATION”; 5,805,703, entitled “METHOD AND APPARATUS FOR DIGITAL SIGNATURE AUTHENTICATION”; and 6,049,610, entitled “METHOD AND APPARATUS FOR DIGITAL SIGNATURE AUTHENTICATION”; each disclose the use of a class of numbers in the form of 2ˆ q-C which make modular reduction more efficient and therefore, make cryptographic methods such as key exchange and digital signatures more efficient. The present invention does not use a class of numbers in the form of 2ˆ q-C. U.S. Pat. Nos. 5,159,632; 5,271,061; 5,463,690; 5,581,616; 5,805,703; and 6,049,610 are hereby incorporated by reference into the specification of the present invention.

Federal Information Processing Standards Publication 186-2 (i.e., FIPS PUB 186-2) discloses a digital signature standard. In the appendix of FIPS PUB 186-2 are recommended elliptic curves for a 192-bit, a 224-bit, a 256-bit, a 384-bit, and a 521-bit digital signature. The elliptic curves disclosed in FIPS PUB 186-2 are different from the elliptic curves used in the present invention.

### SUMMARY OF THE INVENTION

It is an object of the present invention to securely encrypt a plaintext message using a modulus of the form selected from the following equations:

p=(2^{dk}−2^{ck}−1)/r,

where 0<2c<=d, where r/=1, and where GCD(c,d)=1, where GCD is a function that returns the greatest common denominator of the variables in parenthesis;

p=2^{dk}−2^{(d-1})k+2^{(d-2)k}−. . . −2^{k}+1)/r,

where d is even, and where k is not equal to 2 (mod 4);

p=(2^{dk}−2^{ck}−1)/r,

where 3d<6c<4d, and where GCD(c,d)=1;

p=(2^{dk}−2^{ck}+1)/r,

where 0<2c<=d, where r/=1, and where GCD(c,d)=1; and

p=(2^{4k}−2^{3k}+2^{2k}+l)/r.

The present invention is a method of performing elliptic curve encryption in an efficient manner (i.e., in fewer steps than the prior art). The first through sixth steps are done by each a potential recipient of a message encrypted by the present invention. The seventh through eleventh steps are the encryption steps of the present invention that are done by a sender. The twelfth through fourteenth steps are done by the recipient to decrypt a message encrypted by the present invention.

The first step of the method is selecting a modulus p in a form of one of the following equations:

p=(2^{dk}−2^{ck}−1)/r,

where 0<2c<=d, where r/=1, and where GCD(c,d)=1;

p=(2^{dk}−2^{(d-1)k}+2^{(d-2)k}−. . . −2^{k}+1)/r,

where d is even, and where k is not equal to 2 (mod 4);

p=(2^{dk}−2^{ck}−1)/r,

where 3d<6c<4d, and where GCD(c,d)=1;

p=(2^{dk}−2^{ck}+1)/r,

where 0<2c<=d, where r/=1, and where GCD(c, d)=1; and

p=(2^{4k}−2^{3k}+2^{2k}+1)/r.

The second step of the method is selecting a curve E and an order q.

The third step of the method is selecting a base point G=(Gₓ, G_{y}) on the elliptic curve E.

The fourth step of the method is generating a private integer w.

The fifth step of the present method is generating a public key W, where W=wG.

The sixth step of the method is distributing p, E, q, G, and W in an authentic manner.

The seventh step of the method is for the sender to retrieve the recipient's public key W.

The eighth step of the method is for the sender to generate a private integer r.

The ninth step of the method is for the sender to generate R=rG using the form of recipient's modulus p, where G is recipient's basepoint, and where R is a point on an elliptic curve.

The tenth step of the method is for the sender to combine r, W, and Musing the form of recipient's modulus p to form ciphertext C.

The eleventh step of the method is for the sender to send (R,C) to the recipient.

The twelfth step of the method is for the recipient to retrieve its private key w.

The thirteenth step of the method is for the recipient to receive (R,C).

The fourteenth step of the method is for the recipient to combine R, w, and C using the form of recipient's modulus p to recover M.

### BRIEF DESCRIPTION OF THE DRAWINGS

FIG. 1 is a list of steps done by each potential recipient;

FIG. 2 is a list of steps for encrypting a message; and

FIG. 3 is a list of steps for decrypting a message encrypted using the steps of FIG. 2.

### DETAILED DESCRIPTION

The present invention is a method of performing elliptic curve encryption in an efficient manner (i.e., in fewer steps than the prior art), using a modulus p in the form selected from one of the following equations:

p=(2^{dk}−2^{ck}−1)/r,

where 0<2c<=d, where r/=1, and where GCD(c,d)=1;

p=(2^{dk}−2^{(d-1)k}+2^{(d-2)k}−. . . −2^{k}+1)/r,

where d is even, and where k is not equal to 2 (mod 4);

p=(2^{dk}−2^{ck}−1)/r,

where 3d<6c<4d, and where GCD(c,d)=1;

p=(2^{dk}−=2^{ck}+1)/r,

where 0<2c<=d, where r/=1, and where GCD(c,d)=1; and

p=(2₄ₖ−2^{3k}+2^{2k}+1)/r.

It has long been known that certain integers are particularly well suited for modular reduction. The best known examples are the Mersenne numbers p=2^{k}−1. In this case, the integers (mod p) are represented as k-bit integers. When performing modular multiplication, one carries out an integer multiplication followed by a modular reduction. One thus has the problem of reducing modulo p a 2k-bit number. Modular reduction is usually done by integer division, but this is unnecessary in the Mersenne case. Let n<p² be the integer to be reduced (modp). Let T be the integer represented by the k most significant bits of n, and U the k least significant bits; thus

n=2^{k}T+U,

with T and U each being k-bit integers. Then

n=T+U(mod p).

Thus, the integer division by m can be replaced by an addition (mod p), which is much faster.

The main limitation on this scheme is the special multiplicative structure of Mersenne numbers. The above technique is useful only when one intends to perform modular arithmetic with a fixed long-term modulus. For most applications of this kind, the modulus needs to have a specific multiplicative structure, most commonly a prime number. The above scheme proves most useful when k is a multiple of the word size of the machine. Since this word size is typically a power of 2, one must choose k which is highly composite. Unfortunately, the Mersenne numbers arising from such k are never prime numbers. It is, therefore, of interest to find other families of numbers that contain prime numbers or almost prime numbers.

One such family is 2^{k}−c, for c positive, which is disclosed in U.S. Pat. Nos. 5,159,632; 5,271,061; 5,463,690; 5,581,616; 5,805,703; and 6,049,610 listed above. The present invention discloses the use of other families of numbers.

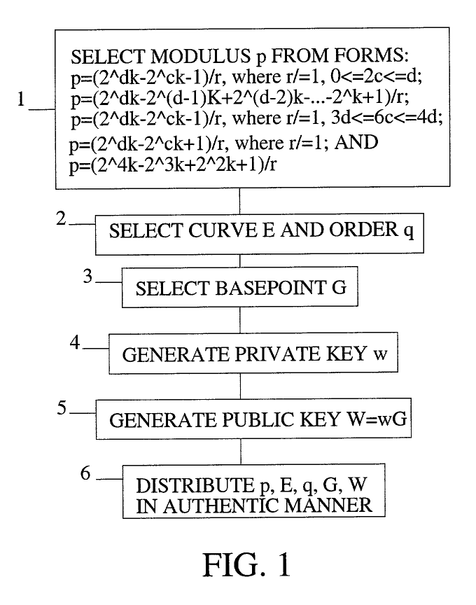

FIG. 1 is a list of steps that must be done by each potential recipient of a message encrypted by the present invention. The first step 1 of the present method is selecting a modulus p in a form of one of the following equations:

p=(2^{dk}−2^{ck}−1)/r,

where 0<2c<=d, where r/=1, and where GCD(c,d)=1;

p=(2^{dk}−2^{(d-1)k}+2^{(d-2)k}−. . . 2^{k}+1)/r,

where d is even, and where k is not equal to 2 (mod 4);

p=(2^{dk}−2^{ck}−1)/r,

where 3d<6c<4d, and where GCD(c,d)=1;

p=(2^{dk}−2^{ck}+1)/r,

where 0<2c<=d, where r/=1 and where GCD(c,d)=1; and

p=(2^{4k}−2^{3k}+2^{2k}+1)/r.

The second step 2 of the present method is selecting a curve E and an order q.

The third step 3 of the present method is selecting base point G=(Gₓ, G_{y}) on the elliptic curve E.

The fourth step 4 of the present method is generating a private integer w.

The fifth step 5 of the present method is generating a public key W, where W=wG.

The sixth step 6 of the present method is distributing p, E, q, G, and W in an authentic manner (e.g., courier, secure channel, etc.).

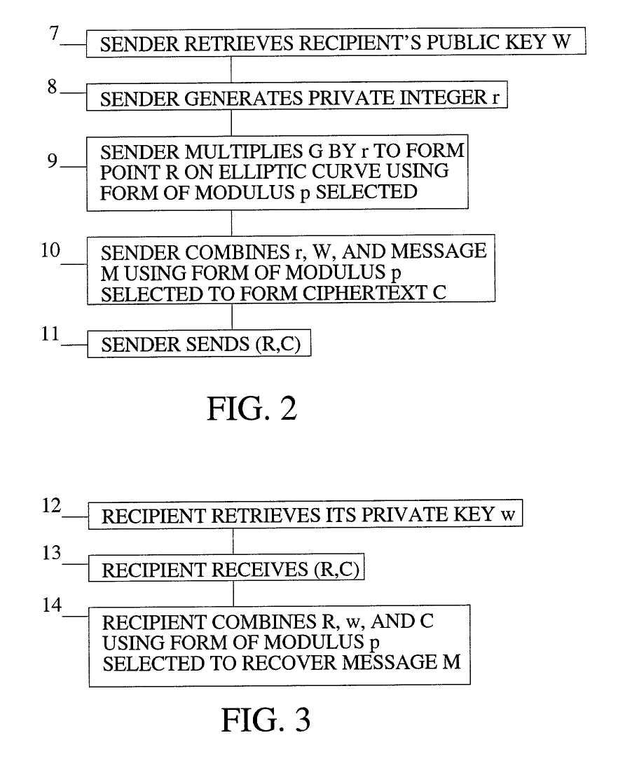

FIG. 2 is a list of steps for a sender to encrypt a message M and send the encrypted message to a recipient who has performed the preliminary steps of FIG. 1.

The seventh step 7 is for the sender to retrieve the recipient's public key W.

The eighth step 8 of the method is for the sender to generate a private integer r.

The ninth step 9 of the method is for the sender to generate R=rG using the form of recipient's modulus p, where G is recipient's basepoint, and where R is a point on an elliptic curve.

The tenth step 10 of the present method is for the sender to combine r, W, and M using the form of recipient's modulus p to form ciphertext C.

The eleventh step 11 of the present method is for the sender to send (R,C) to the recipient.

FIG. 3 is a list of steps for a recipient to decrypt a message that was encrypted for the recipient using the steps of FIG. 2.

The twelfth step 12 of the present method is for the recipient to retrieve its private key w.

The thirteenth step 13 of the present method is for the recipient to receive (R,C).

The fourteenth step 14 of the present method is for the recipient to combine R, w, and C using the form of recipient's modulus p to recover M.

What is claimed is:

1. A method of cryptographic encryption, comprising the steps of:
a) selecting, by a recipient, a modulus p from a group of equations consisting of:
p=(2^{dk}−2^{ck}−1)/r,
where 0<2c<=d, where r/=1, and where GCD(c,d)=1;
p=(2^{dk}−2^{(d-1)k}+2^{(d-2)k}−. . . 2^{k}+1)/r,
where d is even, and where k is not equal to 2 (mod 4);
p=(2^{dk}−2^{ck}−1)/r,
where 3d<6c<4d, and where GCD(c,d)=1;
p=(2^{dk}−2^{ck}−1)/r,
where 0<2c<=d, where r/=1, and where GCD(c,d)=1; and
p=(2^{4k}−2^{3k}+2^{2k}+1)/r.
b) selecting, by the recipient, a curve E and an order q;
c) selecting, by the recipient, a base point G=(Gₓ, G_{y}) on the elliptic curve E;
d) generating, by the recipient, a private integer w;
e) generating, by the recipient, a public key W, where W=wG;
f) distributing, by the recipient, p, E, q, G, and W in an authentic manner;
g) retrieving, by a sender, the recipient's public key W;
h) generating, by the sender, a private integer r;
i) generating, by the sender, R=rG using the form of recipient's modulus p, and where G is recipient's basepoint;
j) combining, by the sender, r, W, and Musing the form of the recipient's modulus p to form ciphertext C; and
k) sending, by the sender, (R,C) to the recipient.

2. The method of claim 1, further including the steps of:
a) retrieving, by the recipient, the recipient's private key w;
b) receiving, by the recipient, (R,C) from the sender; and
c) combining, by the recipient, R, w, and C using the form of the recipient's modulus p to recover M.
